(19) United States
(12) Patent Application Publication
(10) Pub. No.: US 2006/0113932 A1
(43) Pub. Date: Jun. 1, 2006

(54) Vibrator unit and portable telephone employing it

(76) Inventors: Teruo Mori, Tokyo (JP); Toshio Chamura, Tokyo (JP); Kunihiro Fukushima, Tokyo (JP)

Correspondence Address: OLIFF & BERRIDGE, PLC, P.O. BOX 19928, ALEXANDRIA, VA, 22320, US

(21) Appl. No.: 10/537,814

(22) PCT Filed: Mar. 1, 2004
(86) PCT No.: PCT/JP04/02520

§ 371 Date: Jun. 7, 2005

(30) Foreign Application Priority Data
Mar. 20, 2003 (JP) 2003-078283

(51) Int. Cl. H04M 1/00; H02K 33/00

(52) U.S. Cl. 318/114; 455/90.3; 455/550.1

(57) ABSTRACT

A vibrating device that can be applied to various purposes other than as a vibrator and that can achieve cost reduction, size reduction, and space saving by a reduction in the number of components, and a mobile phone using this vibrating device are provided. The vibrating device has a housing supported by a base and capable of oscillating in a vibration frequency range of a vibrator, and an expandable rod that can expand and contract, one end of which is fixed to the housing, and the other end of which is a free end contacting the base. The base is resonated by oscillation of the housing in the vibration frequency range of a vibrator, while the base is vibrated by expansion and contraction of the expandable rod in a sound frequency range other than the vibration frequency range of a vibrator.

### TECHNICAL FIELD

The present invention relates to a vibrating device and a mobile phone using the same, and more particularly to a vibrating device that can be applied to various purposes other than as a vibrator and that can achieve cost reduction, size reduction, and space saving by a reduction in the number of components, and a mobile phone using this vibrating device.

### BACKGROUND ART

Conventionally, there have been widely known mobile phones that vibrate to indicate a phone call (see, for example, Japanese Patent Laid-Open Publication No. Hei 9-18555).

Generally, the mobile phone of this type employs a vibrating device that generates vibration by rotating an eccentric weight with a motor, whereby its casing is vibrated.

However, these conventionally known vibrating devices tend to be large because of the use of a motor, and were not necessarily most suitable for mobile phones, which are required to be small. Moreover, it has become common in recent years that a mobile phone includes a camera, a recording device, and the like therein in addition to the vibrating device, and so a reduction of the number of components and space saving in the phone are demanded.

### DISCLOSURE OF THE INVENTION

The present invention was devised to solve these problems, and an object of the invention is to provide a vibrating device that can be applied to various purposes other than as a vibrator and that can achieve cost reduction, size reduction, and space saving by a reduction in the number of components, and a mobile phone using this vibrating device.

As a result of study, the inventor of the present invention has developed a vibrating device that can be applied to other purposes than as a vibrator and a mobile phone using the same.

In other words, the following present invention can achieve the foregoing object.

(1) A vibrating device having: a housing supported by a base and capable of oscillating relative to the base in a vibration frequency range of a vibrator; and an expandable rod that can expand and contract, one end of which is fixed to the housing, and the other end of which is a free end contacting the base, wherein the base is resonated by oscillation of the housing in the vibration frequency range of a vibrator, and the base is vibrated by expansion and contraction of the expandable rod in a sound frequency range other than the vibration frequency range of a vibrator.

(2) The vibrating device according to (1), wherein the housing includes an inertial mass member, and the one end of the expandable rod is fixed to the inertial mass member.

(3) The vibrating device according to (1) or (2), wherein the housing is supported on the base by a support member having vibration transmission characteristics that allow oscillation of the housing in the vibration frequency range of a vibrator and restrict oscillation of the housing in the sound frequency range.

(4) The vibrating device according to (3), wherein the support member supports part of the housing such that the housing can oscillate around the vicinity of the part acting as a fulcrum point, and supports another part of the housing a distance away from the part via a resilient member having the vibration transmission characteristics.

(5) The vibrating device according to (3), wherein the support member supports the housing in a suspended state such that the housing can oscillate around the free end of the expandable rod acting as a fulcrum point, and has a resilient member having the vibration transmission characteristics in a direction of oscillation of the housing.

(6) The vibrating device according to any one of (1) to (5), wherein at least part of the expandable rod is formed of a displacement rod made of a displacement element.

(7) The vibrating device according to (6), wherein the expandable rod is formed of the displacement rod and a transmission rod having the free end for transmitting a displacement in the displacement rod to the base, the free end of the transmission rod being contacted to the base at a position offset from an axial center of the displacement rod.

(8) The vibrating device according to (6) or (7), wherein the displacement rod is made of a magnetostrictive element including a giant magnetostrictive element.

(9) The vibrating device according to (8), further comprising:

a biasing magnet arranged at both axial ends of the displacement rod made of the magnetostrictive member, for applying a bias magnetic field to the displacement rod in an axial direction; and

a magnet coil arranged to surround the displacement rod, for causing the displacement rod to expand and contract by controlling intensity of the applied magnetic field.

(10) A mobile phone characterized in that the vibrating device according to any one of (1) to (9) is provided in a casing.

(11) The mobile phone according to (10), wherein the casing serves as a speaker of a receiver for generating a conversation sound, a speaker of a call alert buzzer, and a vibrating member of a call alert vibrator.

(12) The mobile phone according to (11), wherein the vibrating device serves as a speaker vibrating device of the receiver, a speaker vibrating device of the call alert buzzer, and a vibrating device of the call alert vibrator.

(13) The mobile phone according to (11) or (12), wherein the speaker of the receiver is a bone conduction speaker that uses the principle of bone conduction.

### BRIEF DESCRIPTION OF THE DRAWINGS

FIG. 1 is a schematic cross-sectional view showing a side cross section of a vibrating device according to an exemplary embodiment of the present invention;

FIG. 2 is a front view of the same vibrating device;

FIG. 3 is a simplified block diagram schematically showing a drive circuit of the vibrating device of FIG. 1; and

FIG. 4 is a schematic cross-sectional view showing a side cross section of a vibrating device according to another exemplary embodiment of the present invention.

### BEST MODE FOR CARRYING OUT THE INVENTION

Exemplary embodiments of the present invention will be hereinafter described with reference to the drawings.

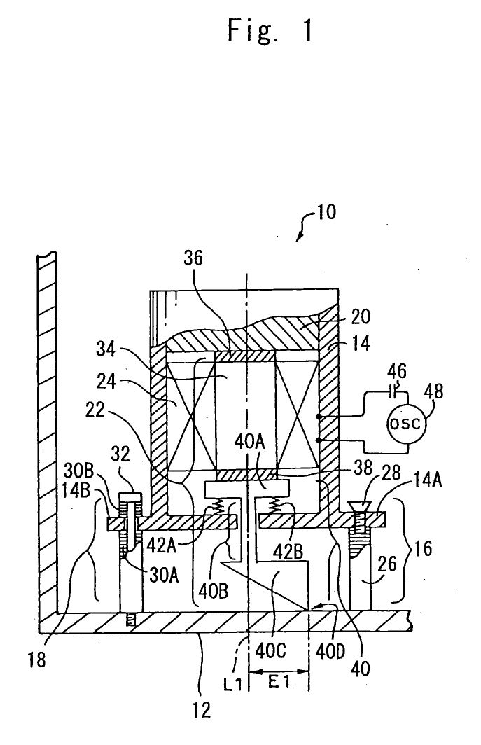

One example, in which the vibrating device 10 according to one exemplary embodiment of the present invention is provided in a casing 12 (only partly shown) of a mobile phone, is described with reference to FIG. 1.

As shown in FIG. 1, the vibrating device 10 generally comprises: a generally cylindrical housing 14; first and second support members 16 and 18, an inertial mass member 20; an expandable rod 22; and a generally cylindrical magnet coil 24. The housing 14 is disposed vertically in FIG. 1 on the casing (base) 12 of the mobile phone. The first and second support members 16 and 18 are arranged on the right and left in FIG. 1 for supporting the housing 14. The inertial mass member 20 is disposed in an upper part of the interior of the housing 14. The expandable rod 22 is arranged vertically below the inertial mass member 20 such that its one end extends through the bottom of the housing 14. The magnet coil 24 is arranged to surround the expandable rod.

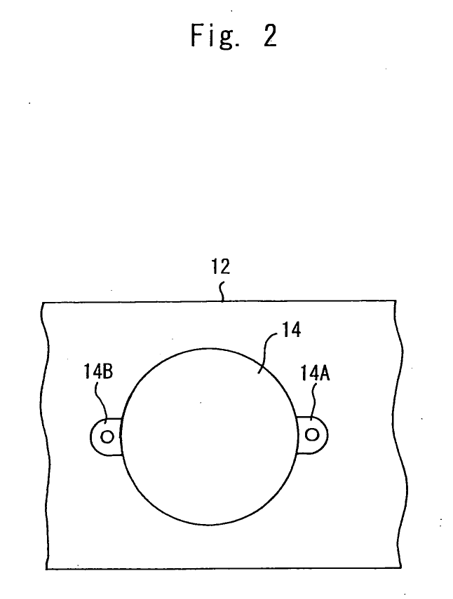

Two, first and second, support frame portions 14A and 14B are integrally formed with the generally cylindrical housing 14 around its circumference at the bottom (see FIG. 2). The first support frame portion 14A on the right side in the drawing is supported by the first support member 16 consisting of a rod-like member 26 integrally formed with the casing 12 and a screw 28 coupled therewith.

On the other hand, the second support frame portion 14B on the left side in the drawing is supported by the second support member 18 formed of two resilient members 30A and 30B and a long screw 32. More specifically, the second support frame portion 14B is provided with a hole that is slightly larger than the outside diameter of the screw 32 fixedly fastened to the casing 12, and is structured to be movable in the up and down directions in the drawing, with the screw 32 being fitted therein. On the upper and lower sides of the second support frame portion 14B are arranged the two resilient members 30A and 30B respectively, such that the second support frame portion 14B is supported by these two resilient members 30A and 30B holding its upper and lower sides.

In other words, the housing 14 is displaceable in the up and down directions in the drawing on the side of the second support frame portion 14B, having a structure capable of oscillating around the vicinity of the first support frame portion 14A acting as a fulcrum point. The resilient members 30A and 30B forming the second support member 18 have vibration transmission characteristics that allow oscillation of the housing 14 in a vibration frequency range of a vibrator and restrict the oscillation of the housing 14 in a sound frequency range.

Here, the “vibration frequency range of a vibrator” in the present invention refers to a frequency range of from several tens to several hundreds Hz, meaning the frequency range that is generally used for driving a vibrator. The “sound frequency range” in the present invention refers to a frequency range of from several hundreds Hz to several tens kHz other than the vibration frequency range of a vibrator, meaning the general audible frequency range for the human ear.

Referring back to FIG. 1, the expandable rod 22 arranged vertically below the inertial mass member 20 is formed of a generally columnar displacement rod 34, two biasing magnets 36 and 38 arranged at both axial ends of the displacement rod 34 for applying a bias magnetic field to the displacement rod 34 in the axial direction, and a transmission rod 40 arranged axially below the displacement rod 34.

The generally columnar displacement rod 34 consists of a giant magnetostrictive member made of a giant magnetostrictive element. The “giant magnetostrictive element” refers to a magnetostrictive element made of a powder sintered alloy or a single-crystal alloy that is mainly composed of a rare earth element and/or specified transition metal (for example, terbium, dysprosium, iron and the like); the element has a characteristic that it generates a large displacement when a magnetic field is applied externally (magnetostrictive effect) The two biasing magnets 36 and 38 are tightly fixed to both axial ends of the displacement rod 34 on one side, while the other side of the biasing magnet 36 that is on the upper side in FIG. 1 is tightly fixed to the inertial mass member 20, and the other side of the biasing magnet 38 on the lower side in the drawing is tightly fixed to the transmission rod 40.

This transmission rod 40 is formed by attaching a component 40C having an inverted triangular side face to one end of a generally columnar member 40B having a disc-like flange portion 40A to be in one-piece therewith such that one top 40D of the triangle is offset from the axial center L1 of the generally columnar member 40B, the top 40D being the free end of the transmission rod 40. In other words, the free end 40D of the transmission rod 40 is contacted to the casing 12 at a position offset by a distance El from the axial center L1 of the displacement rod 34. Between the flange portion 40A of the transmission rod 40 and the housing 14 are arranged springs 42A and 42B to bias the flange portion 40A away from the housing 14.

The generally cylindrical magnet coil 24 is arranged to surround the outer circumference of the displacement rod 34 of the expandable rod 22, and has a structure that allows control of the intensity of the magnetic field applied to the displacement rod 34. To the magnet coil 24 is connected a pulse oscillator 48, which is the drive power supply source of the displacement rod 34, via a coupling condenser 46. The pulse oscillator 48 is configured such as to be capable of outputting both vibration pulses in the vibrator frequency range and sound pulses in the sound frequency range.

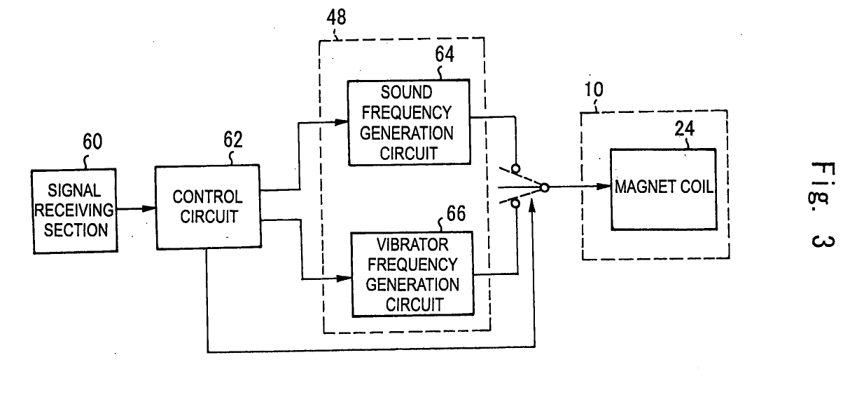

Next, how the vibrating device 10 operates is described with reference also to the simplified block diagram of FIG. 3.

When a call signal is input to a signal receiving section 60 of the mobile phone, the call signal is transmitted to a control circuit 62. The control circuit 62 then decides whether the call recipient shall be alerted by a call alert s buzzer (sound) or a call alert vibrator (vibration), depending on the mode generally provided in the mobile phone.

When alerting the call recipient by the buzzer, a sound pulse signal in the sound frequency range is generated in a sound frequency generation circuit 64 and supplied to the magnet coil 24. The sound pulse signal supplied to the magnet coil 24 changes the intensity of the magnetic field applied to the displacement rod 34. As a result, an axial displacement is generated in the displacement rod 34 due to the magnetostrictive effect, causing the expandable rod 22 to repeat expansion and contraction at a sound frequency.

In this case, since the free end 40D of the expandable rod 22 is contacted to the casing 12, the stress applied from the expandable rod 22 causes the housing 14 to oscillate, with the first support frame portion 14A acting as a fulcrum point. However, as noted above, the resilient members 30A and 30B of the second support member 18 have vibration transmission characteristics that restrict oscillation of the housing 14 in the sound frequency range. Therefore, when a sound pulse signal in the sound frequency range is supplied to the magnet coil 24, the oscillation of the housing 14 is restricted, and the casing 12 is vibrated at a sound frequency by the expansion and contraction of the expandable rod 22. Thus the sound pulse signal of the buzzer is converted into the vibration of the casing 12, which serves as a speaker to output the sound.

On the other hand, when alerting the call recipient by the vibrator, a vibration pulse signal in the vibrator frequency range is generated in a vibrator frequency generation circuit 66 and supplied to the magnet coil 24. As a result, as with the buzzer, a displacement is generated in the displacement rod 34 due to the magnetostrictive effect, causing the expandable rod 22 to repeat expansion and contraction at a vibrator frequency.

In this case, as noted above, since the resilient members 30A and 30B of the second support member 18 have vibration transmission characteristics that allow oscillation of the housing 14 in the vibrator frequency range, the housing 14 oscillates around the first support frame portion 14A acting as a fulcrum point, and this oscillation resonates the casing 12. Thus the vibration pulse signal of the vibrator is transmitted to the outside by the resonance of the casing 12.

When the signal receiving section 60 receives a sound signal of a conversation sound, it is converted into vibration of the casing 12 via the same path as with the buzzer, and the casing 12 serves as a speaker to output the sound. In this case, however, the casing 12 can output the sound at a lower sound level than the case with the sound signal of the buzzer from the sound frequency generation circuit 64, because the casing 12 can function as a bone conduction speaker that uses the principle of bone conduction.

With the vibrating device 10 according to the exemplary embodiment of the present invention, in the vibration frequency range of a vibrator, the casing 12 is resonated by the oscillation of the housing 14, while in the sound frequency range other than the vibration frequency range of a vibrator, the casing 12 is vibrated by the expansion and contraction of the expandable rod 22, whereby the vibrating device 10 can be applied to various purposes other than as a vibrator. Accordingly, as noted above, by providing this vibrating device 10 in the casing 12 of the mobile phone, the vibrating device 10 can be made to function as a speaker vibrating device of the receiver, a speaker vibrating device of the call alert buzzer, and a vibrating device of the call alert vibrator, whereby cost reduction, size reduction, and space saving are achieved by a reduction in the number of components. Moreover, as the casing 12 functions as the speaker of the receiver for generating a conversation sound, the speaker of the call alert buzzer, and a vibrating member of the call alert vibrator, further reductions in the cost, size and the like are possible.

Also, as the displacement rod 34 consists of a giant magnetostrictive member made of a giant magnetostrictive element, an increase in the vibration intensity can be achieved while achieving size reduction of the device at the same time.

Furthermore, because the expandable rod 22 is formed of the displacement rod 34 and the transmission rod 40 and the free end 40D of the transmission rod 40 is contacted to the casing 12 at a position offset from the axial center L1 of the displacement rod 34, the vibration intensity of the oscillation of the housing 14, i.e., of the resonance of the casing 12, in the vibrator frequency range can be increased with a simple structure.

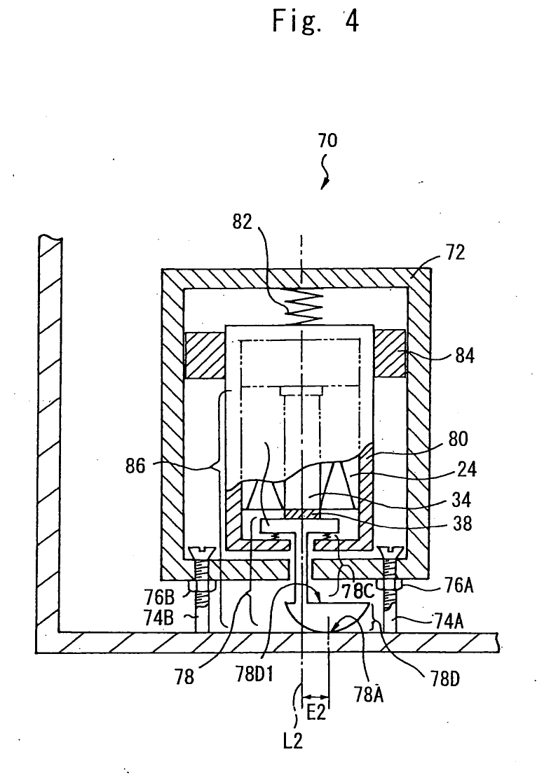

It should be noted that the present invention should not be limited to the structure, shape and the like of the vibrating device 10 according to the above-described exemplary embodiment and the invention includes other designs as long as the vibrating device has a housing supported on a base and capable of oscillating in a vibration frequency range of a vibrator, and an expandable rod that can expand and contract, one end of which is fixed to the housing, and the other end of which is a free end contacting the base. Accordingly, a vibrating device 70 shown in FIG. 4, for example, is also included in the invention.

This vibrating device 70 employs a generally cylindrical case-like outer housing 72 instead of the first and second support members 16 and 18 of the above-described vibrating device 10 shown in FIG. 1. The features similar to the vibrating device 10 will not be described again.

The generally cylindrical case-like outer housing 72 is rigidly attached to the casing 12 with two pairs of bolts 74A and 74B and nuts 76A and 76B. A housing 80 having a transmission rod 78 and others is accommodated inside the outer housing 72 vertically in the drawing.

The housing 80 is supported in a suspended state with a spring 82 hung from the top inside the outer housing 72, and is also supported by the transmission rod 78 extending to the outside of the outer housing 72, to have a structure capable of oscillating around the free end 78A of the transmission rod 78 acting as a fulcrum point. In the inner surface of the outer housing 72 in a direction in which the housing 80 oscillates is arranged a resilient member 84 such as to surround the side face of the housing 80. The resilient member 84 has vibration transmission characteristics that allow oscillation of the housing 80 in a vibration frequency range of a vibrator and restrict the oscillation (movements of the housing 80 in the axial direction L2 and in the radial direction) of the housing 80 in a sound frequency range.

The transmission rod 78 is formed by attaching a circular end face 78D1 of a generally semi-spherical member 78D to one end of a generally columnar member 78C having a disc-like flange portion 78B such that the center of the circular end face is offset from the axial center L2 of the generally columnar member 78C. In other words, the free end 78A of this transmission rod 78 is contacted to the casing 12 at a position offset by a distance E2 from the axial center L2 of the transmission rod 34.

The vibrating device 70 operates as follows.

When a sound pulse signal in the sound frequency range is supplied to the magnet coil 24, causing the expandable rod 86 to expand and contract at a sound frequency, the stress applied from the expandable rod 86 causes the housing 80 to oscillate, with the free end 78A of the expandable rod 86 acting as a fulcrum point. However, as noted above, the resilient member 84 has vibration transmission characteristics that restrict oscillation of the housing 80 in the sound frequency range. Therefore, when a sound pulse signal in the sound frequency range is supplied to the magnet coil 24, the oscillation (movements of the housing 80 in the axial direction L2 and in the radial direction) of the housing 80 is restricted, and the casing 12 is vibrated at a sound frequency by the expansion and contraction of the expandable rod 86. Thus the sound pulse signal of the buzzer or a conversation sound is converted into the vibration of the casing 12, which serves as a speaker to output the sound.

On the other hand, when a vibration pulse signal in the vibrator frequency range is supplied to the magnet coil 24, the housing 80 oscillates around the free end 78A of the expandable rod 86 acting as the fulcrum point because the resilient member 84 has vibration transmission characteristics that allow oscillation of the housing 80 in the vibration frequency range of a vibrator, and this oscillation resonates the casing 12. Thus the vibration pulse signal of the vibrator is transmitted to the outside by the resonance of the casing 12.

The same effects as with the above-described vibrating device 10 can be achieved with this vibrating device 70.

While the displacement rod 34 of the expandable rod 22 consists of a giant magnetostrictive member made of a giant magnetostrictive element in the above-described exemplary embodiment, the present invention is not limited to this. Therefore, for example, the rod may be made of a magnetostrictive element, or of any other displacement elements such as a piezoelectric element or the like.

The purpose of use of the vibrating device according to the present invention should not be limited to mobile phones.

### INDUSTRIAL APPLICABILITY

The vibrating device of the present invention can be applied to various purposes other than as a vibrator, and provides excellent effects such as cost reduction, size reduction, and space saving by a reduction in the number of components.

1-13. (canceled)

14. A vibrating device having:
a housing supported by a base and capable of oscillating relative to the base in a vibration frequency range of a vibrator; and
an expandable rod that can expand and contract, one end of which is fixed to the housing, and the other end of which is a free end contacting the base, wherein the base is resonated by oscillation of the housing in the vibration frequency range of a vibrator, and the base is vibrated by expansion and contraction of the expandable rod in a sound frequency range other than the vibration frequency range of a vibrator.

15. The vibrating device according to claim 14, wherein
the housing includes an inertial mass member, and the one end of the expandable rod is fixed to the inertial mass member.

16. The vibrating device according to claim 14, wherein
the housing is supported on the base by a support member having vibration transmission characteristics that allow oscillation of the housing in the vibration frequency range of a vibrator and restrict oscillation of the housing in the sound frequency range.

17. The vibrating device according to claim 15, wherein
the housing is supported on the base by a support member having vibration transmission characteristics that allow oscillation of the housing in the vibration frequency range of a vibrator and restrict oscillation of the housing in the sound frequency range.

18. The vibrating device according to claim 16, wherein
the support member supports part of the housing such that the housing can oscillate around the vicinity of the part acting as a fulcrum point, and supports another part of the housing a distance away from the part via a resilient member having the vibration transmission characteristics.

19. The vibrating device according to claim 16, wherein
the support member supports the housing in a suspended state such that the housing can oscillate around the free end of the expandable rod acting as a fulcrum point, and has a resilient member having the vibration transmission characteristics in a direction of oscillation of the housing.

20. The vibrating device according to claim 14, wherein
at least part of the expandable rod is formed of a displacement rod made of a displacement element.

21. The vibrating device according to claim 15, wherein
at least part of the expandable rod is formed of a displacement rod made of a displacement element.

22. The vibrating device according to claim 16, wherein
at least part of the expandable rod is formed of a displacement rod made of a displacement element.

23. The vibrating device according to claim 18, wherein
at least part of the expandable rod is formed of a displacement rod made of a displacement element.

24. The vibrating device according to claim 19, wherein
at least part of the expandable rod is formed of a displacement rod made of a displacement element.

25. The vibrating device according to claim 20, wherein
the expandable rod is formed of the displacement rod and a transmission rod having the free end for transmitting a displacement in the displacement rod to the base, the free end of the transmission rod being contacted to the base at a position offset from an axial center of the displacement rod.

26. The vibrating device according to claim 20, wherein
the displacement rod is made of a magnetostrictive element including a giant magnetostrictive element.

27. The vibrating device according to claim 25, wherein
the displacement rod is made of a magnetostrictive element including a giant magnetostrictive element.

28. The vibrating device according to claim 26, further comprising:
a biasing magnet arranged at both axial ends of the displacement rod made of the magnetostrictive member, for applying a bias magnetic field to the displacement rod in an axial direction; and
a magnet coil arranged to surround the displacement rod, for causing the displacement rod to expand and contract by controlling intensity of the applied magnetic field.

29. A mobile phone characterized in that the vibrating device according to claim 14 is provided in a casing.

30. The mobile phone according to claim 29, wherein
the casing serves as a speaker of a receiver for generating a conversation sound, a speaker of a call alert buzzer, and a vibrating member of a call alert vibrator.

31. The mobile phone according to claim 30, wherein
the vibrating device serves as a speaker vibrating device of the receiver, a speaker vibrating device of the call alert buzzer, and a vibrating device of the call alert vibrator.

32. The mobile phone according to claim 30, wherein
the speaker of the receiver is a bone conduction speaker that uses the principle of bone conduction.

33. The mobile phone according to claim 31, wherein
the speaker of the receiver is a bone conduction speaker that uses the principle of bone conduction.
